(19) United States
(12) Patent Application Publication
(10) Pub. No.: US 2008/0302866 A1
(43) Pub. Date: Dec. 11, 2008

(54) METHOD FOR CREATING A LABEL, COMPUTER PROGRAM PRODUCT AND LOGISTICS SYSTEM

(76) Inventors: Michael Baugh, Phoenix, AZ (US); Sarah Ritthaler, Scottsdale, AZ (US)

Correspondence Address: International IP Law Group, P.O. BOX 691927, HOUSTON, TX, 77269-1927, US

(21) Appl. No.: 12/134,796

(22) Filed: Jun. 6, 2008

Related U.S. Application Data
(60) Provisional application No. 60/933,425, filed on Jun. 6, 2007.

(51) Int. Cl. G06F 17/00

(52) U.S. Cl. 235/375; 400/76; 235/494

(57) ABSTRACT

There is provided a method and logistics system for creating a label. An exemplary method comprises creating allowance information to allow an original receiver to enter shipment information and allowing the original receiver to activate an option to create a return label. The exemplary method further comprises enabling the original receiver of the item to print the return label.

### CROSS-REFERENCE TO RELATED APPLICATION

This application claims priority of U.S. Provisional Patent Application Ser. No. 60/933,425, filed Jun. 6, 2007 entitled “Method for creating a Label, Computer Program Product and Logistics System” by Baugh, et al., the contents of which are incorporated by reference as though fully set forth herein.

### BACKGROUND

Exemplary embodiments of the present invention relate to a method for delivering items with a return component. In addition, exemplary embodiments of the present invention concern a system for carrying out the method.

It is known, to attach return labels to items—especially to postal deliveries. Normally such return labels are attached to a delivery, which is sent from an original shipper to an original receiver.

### SUMMARY OF THE INVENTION

It is desirable to provide a procedure for producing a return label which allows a flexible production of the label. Exemplary embodiments of the present invention relate to a system and method for producing labels in a way that affords high comfort as well as protection against manipulation.

Exemplary embodiments of the present relate to a method for creating a label, characterized in that an original shipper creates allowance information which allows an original receiver to enter shipment information and to activate an option for a creation of a return label. The original receiver of the item is enabled to print the return label.

It is especially advantageous that the original receiver is enabled to modify the shipment information.

In a preferred embodiment of the invention a link to the return label is transmitted to the original receiver.

Exemplary embodiments of the present invention may relate to a computer program product, which is characterized in that it contains program means for implementing the method.

An exemplary embodiment of the present invention is may provide a user interface which allows an original shipper to create an allowance information which allows an original receiver to enter shipment information and to activate an option for a creation of a return label, and that it contains an user interface which allows an original receiver to print and/or modify the return label.

One exemplary embodiment of the present invention includes a method, a system and a computer program product, which is characterized in that it contains a user interface which allows the original shipper to create an allowance information which allows the original receiver to enter shipment information and to activate an option for a creation of a return label and that a user interface which allows the original receiver to print and/or to modify the return label.

Advantages, further aspects and advantageous improvements of the invention are afterwards explained by examples with reference to the figures.

It is especially advantageous to utilise an exemplary embodiment of the present invention for production of return labels. These labels may be attachable to items—especially to postal deliveries as letters or parcels—to facilitate their handling in a logistics system.

### BRIEF DESCRIPTION OF THE DRAWINGS

FIG. 1, which comprises FIG. 1a and FIG. 1b, is a flow diagram showing process steps carried out by an original shipper to produce a return label and/or a message enabling an original receiver to produce the return label in accordance with an exemplary embodiment of the present invention;

FIG. 2 is a flow diagram showing process steps which enable an original receiver to produce a return label in accordance with an exemplary embodiment of the present invention;

FIG. 3 is a flow diagram showing a process overview for creating and handling one or more return labels in accordance with an exemplary embodiment of the present invention;

FIG. 4 is a diagram showing information flow between a webpage for preparing a shipment and a webpage for creating a return label in accordance with an exemplary embodiment of the present invention; and

FIG. 5 is a diagram of a webpage for entering delivery options for implementation in the return label in accordance with an exemplary embodiment of the present invention.

### DETAILED DESCRIPTION OF SPECIFIC EMBODIMENTS

Exemplary embodiments of the present invention include logistics systems in their broadest sense this especially includes systems, which contain means and/or arrangements for carrying out the transport and/or handling of items. This especially encompasses a transport of items—especially of postal deliveries—from a starting point to a destination along a transport route.

The starting point is especially a storage point or a drop point of the item which is transported later on.

The destination is preferably selected by a customer. By a return process the destination is for example a warehouse of a merchant or a producer.

It is especially advantageous to use the labels according to an exemplary embodiment of the present invention as return labels.

Especially preferred embodiment of a label according to an exemplary embodiment of the present invention may be called premium e-mail label.

With a return service a logistics system provider sends a return label via e-mail to the recipient who specifies and allows the shipper to define what parts of the return label can be modified. As an example the shipper may allow the receiver to change the service type from Ground to Express. This option will also allow the shipper to lock the shipment details such as weight and dimensions or leave them open for the shipper to modify. Once the recipient has modified the shipment details then the waybill can be printed and attached to the package for a return. This option allows the shipper to reach any receiver and the receiver is not required to be an existing customer of the logistic system provider.

To allow the receiver to access the return label, a link is provided to the receiver.

The link can be provided in different ways, e.g. as an e-mail by a push based web service.

A hyperlink is a preferred embodiment of a link according to an exemplary embodiment of the present invention. It is a reference or navigation element in a document to another section of the same document, another document, or a specified section of another document, that automatically brings the referred information to the user when the navigation element is selected by the user. As such it is similar to a citation in literature, but with the distinction of automatic instant access. Combined with a data network and suitable access protocol, a computer can be instructed to fetch the resource referenced.

Hyperlinks are not limited to HTML or the web. Hyperlinks may be used in almost any electronic media.

There are a number of ways to format and present hyperlinks in hypermedia. What distinguishes the various formats of links are the various ways in which links are accessed. Most links are accessed via selecting (pointing and clicking) hypertext or a graphical user interface element (widget) such as a button.

A link has two ends, called anchors, and a direction. The link starts at the source anchor and points to the destination anchor. However, the term link is often used for the source anchor, while the destination anchor is called the link target.

Such links are implemented in different ways. Exemplary embodiments of the present invention may provide ways to transmit the links to the receiver. Especially advantageous are links which are supplied per e-mail or by a call of a webpage.

A preferred embodiment of the invention is carried out with an internet based system as web ship/corporate ship.

The internet comprises a high number of computers and network links between the computers. Preferably applicable protocols and standards apply to allow a communication. The World Wide Web (“WWW”) allows an interphase for carrying out operations on the internet. The World Wide Web allows a server computer—referred as a website—to send web pages of information to a remote computer and allow the remote representatives computer to display the web pages on a display. The web pages may contain control regions. These control regions allow an acquisition and display of additional information, especially in form of related web pages, especially in a hypertext mode.

The internet allows an information exchange from servers to clients. Each client and server has an internet address called a uniform resource locator (“URL”).

A web page according to an exemplary embodiment of the present invention is especially designed in hypertext mark up language (“HTML”) or in extended hypertext mark up language (“XTML”). The HTML or XTML file defines the web page. In a preferred embodiment servers are used, which are stateless with respect to a client transactions. This means, that each transaction is separate from other transactions. Alternatively a client might initialize a connection to the server, conduct a series of requests from the server and receive information for each request, and then terminate the connection from the server and the entire exchange from the initialization to the termination of the connection would be considered a transaction.

The scope of exemplary embodiments of the present invention includes modifications to Web/Corporate Ship, and may define the internal processes and technical specifications necessary to support a Return Labels process for domestic shipments on Web/Corporate Ship. Users have the ability to create online return labels and either mail or e-mail the completed label to the shipper. The return label creator has the ability to bill the freight charges to the sender, receiver or third party account.

To allow a flexible creation and handling of the label, it is advantageous to include at least one link in a handling process.

Links pointing to the full content may also be included in the label. One or more links may be included in the preview information. According to another embodiment, the device may automatically configure the links based on their personalized information. The device could fill in the parts of the link relevant to the user of the device. For example, the device may place the user's zip code in a link to retrieve the full address information for the user.

A preferred method for producing labels according to an exemplary embodiment of the present invention is, for example, supported in a web based system, for example in Web Ship or Corporate Ship.

Preferably a first user—original shipper—is authenticated and navigates to prepare a shipment page and selects an appropriate destination.

The authentication of the original shipper and the preparation of the shipment page processes are carried out to allow a product and/or a preparation of the return label.

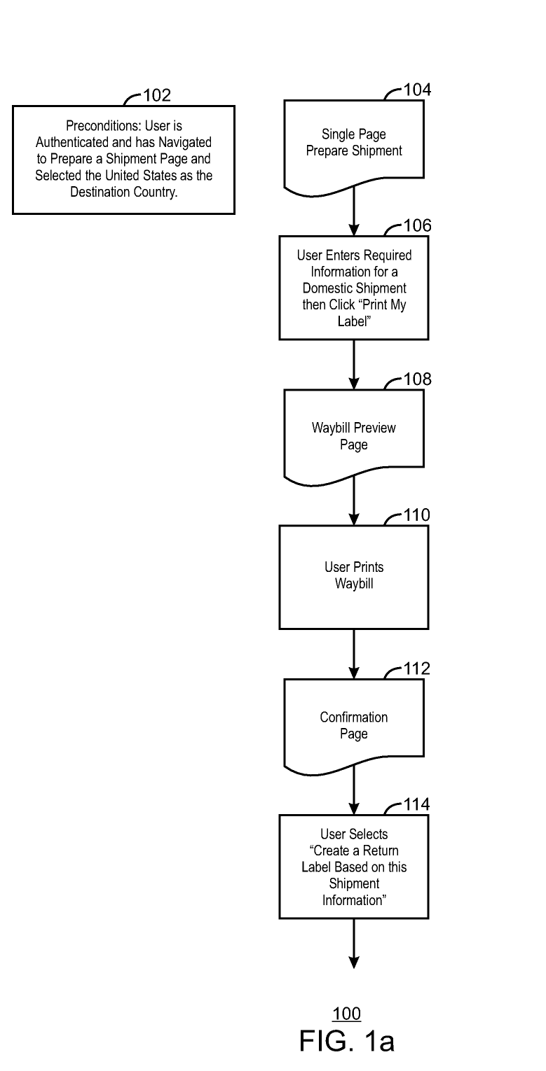

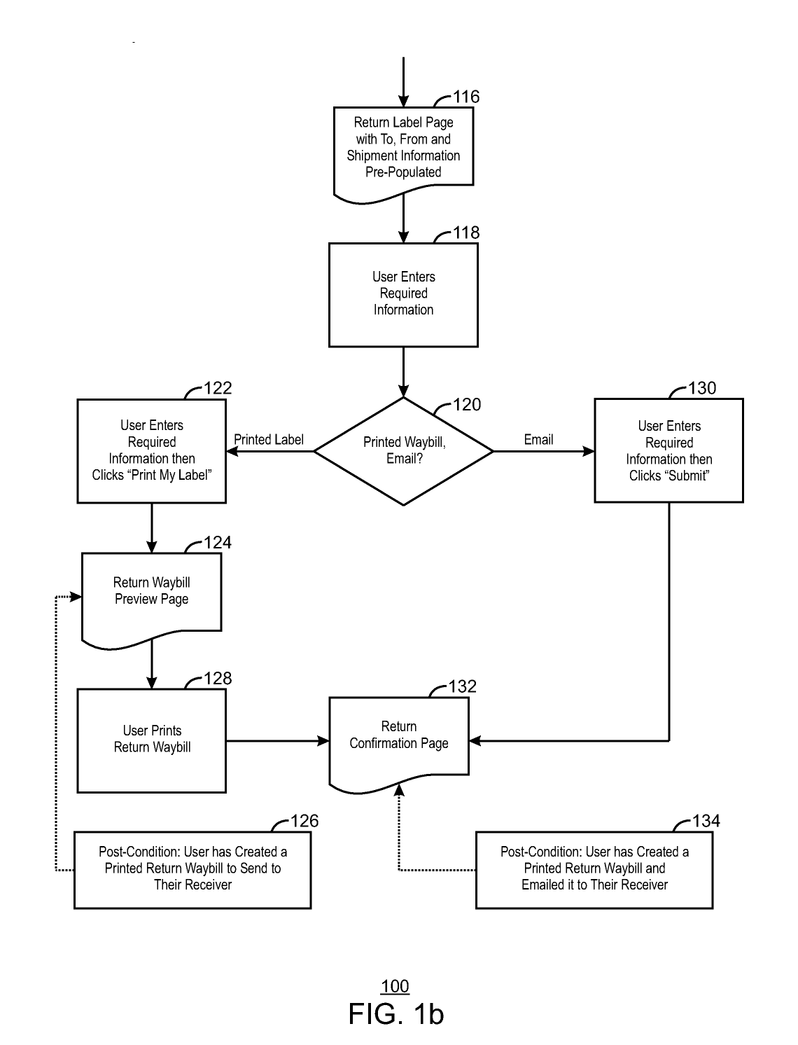

Preferably processes are described in FIG. 1.

FIG. 1 is a flow diagram showing process steps carried out by an original shipper to produce a return label and/or a message enabling an original receiver to produce the return label in accordance with an exemplary embodiment of the present invention. The flow diagram is generally referred to by the reference number 100. The original shipper is a user, who enters required information for a shipment. A precondition block 102 indicates that preconditions to the exemplary method shown in FIG. 1 include that a user has been authenticated, has navigated to prepare a shipment page and has selected the U.S. as the destination country.

As indicated at block 104, the exemplary method relates to the use of a single page to prepare a shipment. At block 106, the user enters information for a domestic shipment and clicks a “print my label” button. This leads to an opening of a waybill preview page, as shown at block 108. Afterwards, the user prints the waybill, as shown at block 110. It is of course alternatively possible to create a digital waybill. A digital waybill is an electronic version of a waybill, which is especially appropriate if shipments are ordered through the internet. A confirmation page is displayed, as shown at block 112.

A waybill is a document issued by a carrier giving details and instructions relating to the shipment of an item or a consignment of items. Typically it will show the names of the consignor and consignee, the point of origin of the consignment, its destination, route, and method of shipment, and the amount charged for carriage.

The waybill may also be a bill of lading, which includes much of the same information. A bill of lading (also referred to as a BOL or B/L) is a document issued by a carrier, e.g. a ship's master or by a company's shipping department, acknowledging that specified goods have been received on board as cargo for conveyance to a named place for delivery to the consignee who is usually identified. A through bill of lading involves the use of at least two different modes of transport from road, rail, air, and sea. The term derives from the noun “bill”, a schedule of costs for services supplied or to be supplied, and from the verb “to lade” which means to load a cargo onto a ship or other form of transport.

A preferred embodiment of the waybill is an Airway Bill (AWB) or an air consignment note or airway bill of lading. It refers to a receipt issued by an international courier company for goods and an evidence of the contract of carriage, but it is not a document of title to the goods.

The AWB has a tracking number which can be used to check the status of delivery, and current position of the item.

The AWB should indicate that the goods have been accepted for carriage, and it must be signed or authenticated by the carrier or the named agent for or on behalf of the carrier. The signature or authentication of the carrier can be identified as carrier, and in the case of agent signing or authenticating, the name and the capacity of the carrier on whose behalf the agent signs or authenticates must be indicated.

International AWBs that contain consolidated cargo are called Master Air Waybills (MAWB). MAWBs have additional papers called House Air Waybills (HAWB). Each HAWB contains information of each individual shipment (consignee, contents, etc.) within the consolidation. International AWBs that is not consolidated (only one shipment in one bill) are called Simple AWBs.

A House Air Waybill can also be created by a freight forwarder. When the shipment is booked, the airline issues a MAWB to the forwarder, who in turn issues their own House Airwaybill to the customer.

After the production of the waybill a return label is created based on the shipment information. Of course, the return label does not need to contain all of the shipment information. It is alternatively possible, that the return label contains only a part of the shipment information.

For creating the return label it is advantageous that a user selects a program option which allows the creation of the return label based on shipment information, as shown at block 114.

Afterwards, a return label page with shipment information is pre-populated, as shown at block 116. Next, the user enters the required information, as shown at block 118.

A selection menu is presented to this user (original shipper). The user can decide whether to print a return label or whether to create an electronic return label, as shown at decision block 120.

If the user decides the option “printed label” required information is entered, as shown at block 122. The user then views a “Return Waybill” preview page, as shown at block 124. As shown at a post-condition block 126, the exemplary method operates under an assumption that the user has created a printed return waybill to send to their receiver. The user then prints the return waybill, as shown at block 128, and returns to a confirmation page, as shown at block 132.

If, at decision block 120, the user decides to create a digital return label, the required information is entered and the user clicks “submit option”, as shown at block 130.

Afterwards, the user returns to a confirmation page, as shown at block 132. As shown by a post-condition block 134, the exemplary method shown in FIG. 1 operates under an assumption that a digital return label has been created and emailed to the user's receiver.

Preferably the return label—especially together with the return waybill—are transmitted to the receiver of the item. It is especially preferably to carry out this transmission in digital form, e.g. as e-mail or through push web-service.

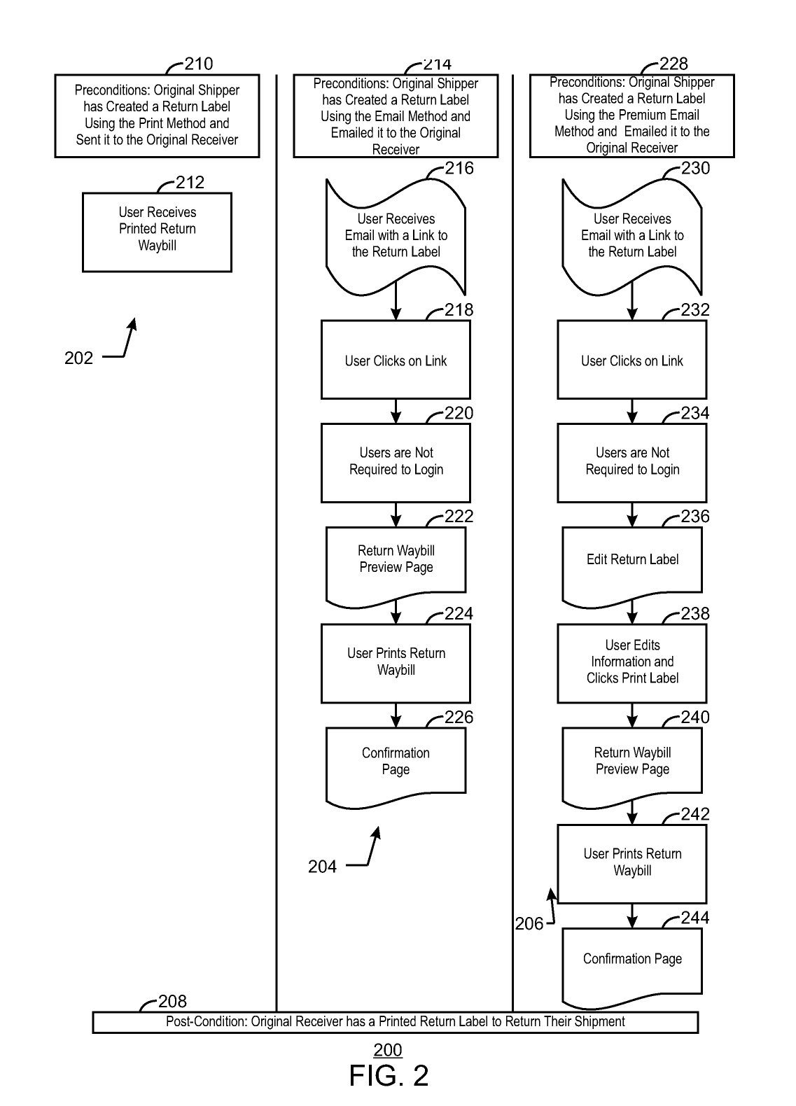

FIG. 2 is a flow diagram showing process steps which enable an original receiver to produce a return label in accordance with an exemplary embodiment of the present invention. The flow diagram is generally referred to by the reference number 200.

FIG. 2 shows three alternatives for producing a return label or a return waybill. A first alternative is shown in a left column 202. A second alternative is shown in a center column 204. Lastly, a third alternative is shown in a right column 206. All three alternatives shown in FIG. 2 are premised upon a post-condition that an original receiver has printed a return label to return their shipment, as shown in a post-condition block 208.

For those skilled in the art, it is clear, that at any place, where waybill is described, alternatively a label can be used. This is also true vice versa.

The left column 202 of FIG. 2 shows the easiest way of producing a return label or a return waybill. The first alternative shown in the left column 202 is premised on a pre-condition that an original shipper has created a return label using the pring method and sent it to the original receiver, as shown at a pre-condition block 210. The first alternative of producing a return label is afterwards called DHL returns. According to the first alternative, the provider of the logistics system allows a user to create a return label and send it to an original receiver of an item. Moreover, the user receives a printed return waybill, as shown at block 212. The transmission of the return label can be carried out together with the shipment or separately.

A more advanced way of producing a return label and/or a return waybill is described in the right column 206 of FIG. 2. This way of producing a return label is afterwards called DHL return e-mail label. The second alternative shown in the right column 206 is premised on the pre-conditions shown in a pre-condition block 228. In particular, the pre-conditions are that an original shipper has created a return label using the pre-return email method and emailed it to the original receiver. The recipient prints the return label and preferably attaches it to an item or a package containing the item to be returned.

This column describes a flow chart for a process in which the original shipper has created a return label digitally and has transmitted it to the original receiver of the item.

The transmission can occur preferably in digital form, e.g. we are a web push service or as an e-mail.

The user receives the information—e.g. in form of an e-mail—with a link to the return label, as shown at block 230.

If the user clicks on a link a return label preview page opens, as shown at block 232. The user is not required to login, as shown at block 234. The user is allowed to edit the return label, as shown at block 236. At block 238, the user edits the information and clicks a “print label” button. A return waybill preview page is displayed, as shown at block 240. At block 242, the user prints the return waybill. Optionally, a confirmation page is shown, as set forth in block 244.

The right column 206 of FIG. 2 shows an alternative solution for producing a digital return label/return waybill. This way of producing a digital return label is afterwards called DHL returns—premium e-mail label. With this return service the provider of the logistics system allows an original shipper to transmit a return label to a recipient. Also in this case the recipient can be specified by the original shipper. With the premium e-mails solution, the recipient has the ability to modify the shipment details prior to printing the label.

A third alternative of printing a return waybill is shown in the center column 204 of FIG. 2. In the third alternative, it is possible that once the recipient has modified the shipment details, a waybill can be printed and attached to the item respectively package for a return. The third alternative shown in the center column of FIG. 2 is premised on pre-conditions set forth in a pre-condition block 214. In particular, the third alternative is premised on pre-conditions that an original shipper has created a return label using the email method and emailed it to the original receiver.

The user receives the information, as shown at block 216, and clicks on a link contained in the information, as shown at block 218. As in the second alternative described above, the user is not required to login, as shown at block 220.

In the third alternative shown in the center column 204, the original receiver is a user who is enabled to add the return label.

The user can e.g. add information—for example for changing transport parameters, e.g. the destination and/or the number of items sent back. This is especially advantageous if the receiver of items is interested in returning only a part of the received items.

Preferably, a return waybill preview page is displayed, as shown at block 222. The return waybill preview page enables the user to view a preview of the intended waybill/label. The user prints the return waybill, as shown at block 224. At block 226, a confirmation page is displayed.

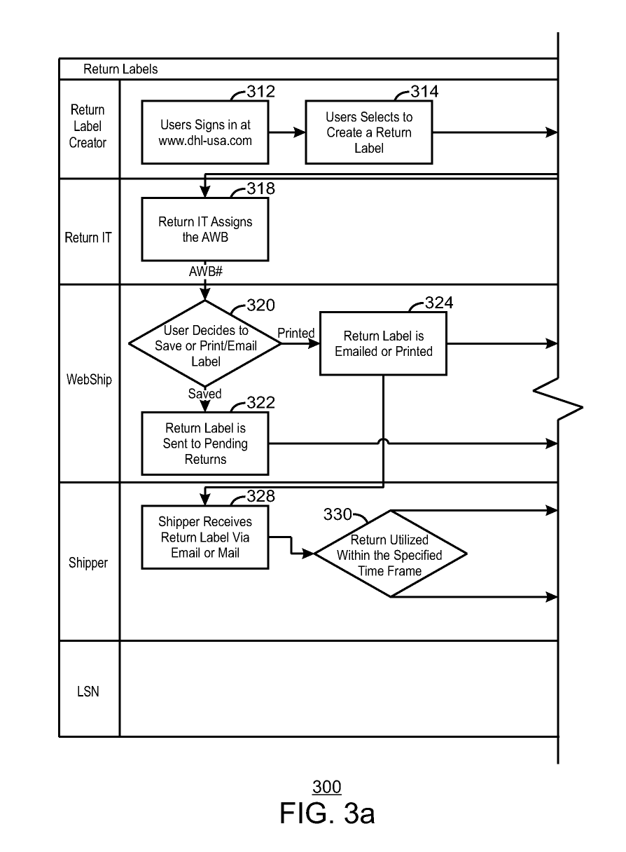

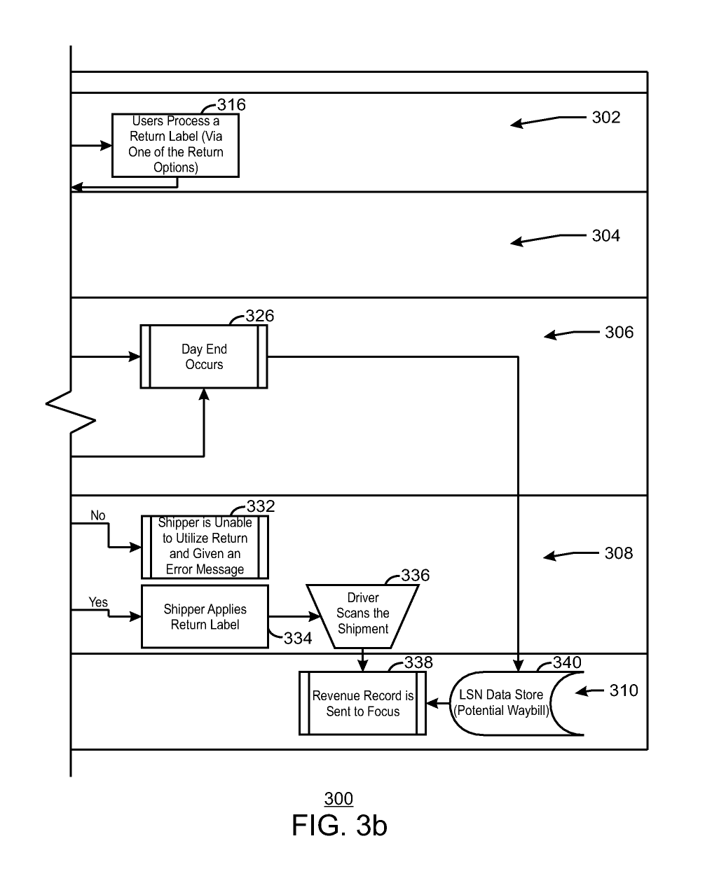

FIG. 3 is a flow diagram showing a process overview for creating and handling one or more return labels in accordance with an exemplary embodiment of the present invention. The flow diagram is generally referred to by the reference number 300. The flow diagram 300 comprises five separate areas, shown as horizontal rows in FIG. 3. The five areas are a Return Label Creator area 302, a Return IT area 304, a WebShip area 306, a Shipper area 308 and an LSN area 310.

The Return Label Creator area 302 comprises a user sign-in block 312. At block 314, the user selects to create a return label. At block 316, the user processes a return label via one of the return options.

Process flow then proceeds to the Return IT area 304. The Return IT area 304 comprises a return IT assignment block 318. At the return IT assignment block 318, an AWB is assigned.

Next, process flow continues to the WebShip area 306. The Webship area 306 comprises a decision block 320. At the decision block 320, the user decides whether to save, print or email a label. If the user decides to save the label, the return label is saved to Pending Returns, as shown at block 322. Next, process flow continues to a Day End Occurs block 326.

If, at the decision block 320, the user decides to print or email the label, the return label is printed or emailed, as shown at block 324. Process flow then proceeds to the Day End Occurs block 326.

The Shipper area 308 comprises a shipper receipt block 328. At the shipper receipt block 328, the shipper receives the return label via email or mail. Process flow then proceeds to a decision block 330. At the decision block 330, a decision is made regarding whether a return is being made within a specified authorized timeframe. If the return is not being made within the specified timeframe, an error message is generated, as shown at block 332, and process flow terminates. If, at the decision block 330, the return is determined to be within the specified timeframe, the shipper applies the return label, as shown at block 334. Next, a driver scans the shipment, as shown at block 336.

Process flow next proceeds to the LSN area 31 0. The LSN area comprises a block 338, in which a revenue record is sent to Focus.

After the Day End Occurs block 326 in the WebShip area 306, process flow continues to an LSN Data Store block 340. Next, the process concludes at the block 338. Further details regarding the exemplary process shown in FIG. 3 are set forth below.

### Returns Back-End Process Overview

WebShip users who print a return label using Web/CorporateShip could have the shipment details stored up to a definable period of time, e.g. several days, preferably between 30 days and a year, e.g. 90 days, as currently implemented. Return labels prepared by a user will have return label details stored in a return label history at least a determinable period of time, e.g. between 30 days and a year, e.g. at least 90 days.

A preferred user interface and functional requirements for a preferred embodiment are afterwards described in a web based solution. This web based solution is called WebShip/CorporateShip.

### The Waybill Preview Page Could Have a Link That Reads “Create a Return Label Based on This Shipment”

### Users

WebShip users with an account successfully creating a domestic shipment who's CA has not disabled return label processing

### Inputs

User fills in all required information for a domestic shipment and clicks charge me and print my label on the Prepare shipment page.

### Outputs

A Create a return label based on this shipment link on the waybill preview page.

The user is enabled to create a return label, especially by following a link. For example this link is “create a return label based on this shipment”.

A User that processes a shipment can follow the link directly. The link leads to a webpage which allows the creation of the return label. Especially the creation of the return label is carried out with pre-populated with information previously entered, e.g. in webpage called “prepare shipment page”.

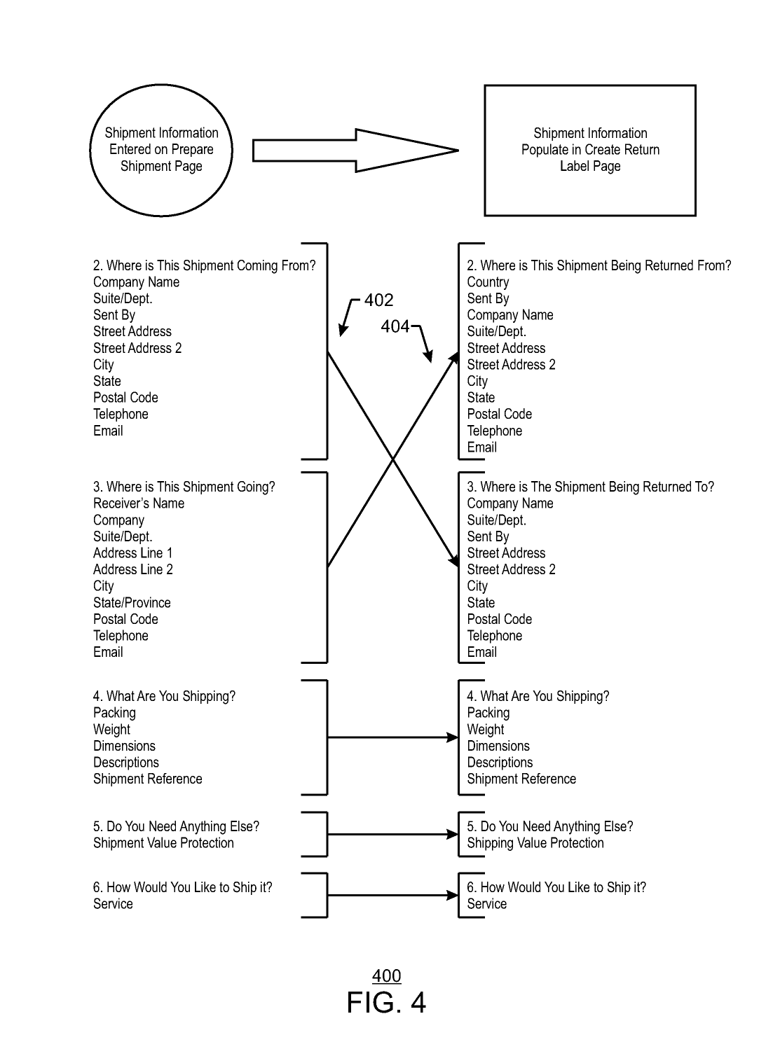

FIG. 4 is a diagram showing information flow between a webpage for preparing a shipment and a webpage for creating a return label in accordance with an exemplary embodiment of the present invention. The diagram is generally referred to by the reference number 400. The diagram 400 shows the flow of information from a shipment information entry column 402 to a shipment information populate column 404.

According to the exemplary embodiment shown in FIG. 4, address the information for a receiver and/or a sender and/or information about items to be transported and other shipment information is transferred from the user page for entering the shipment information to the user page for creating the return label.

### Users Could Have the Option to Create a Return Label Based on Their Outbound Shipment on the WebShip Shipment Preparation Page.

### Users

WebShip users with an account and CorpShip users if the CA has enabled the use of Return Labels.

### Inputs

User navigates to WebShip/CorporateShip.

### Outputs

A return waybill or a populated Create a Return Label page.

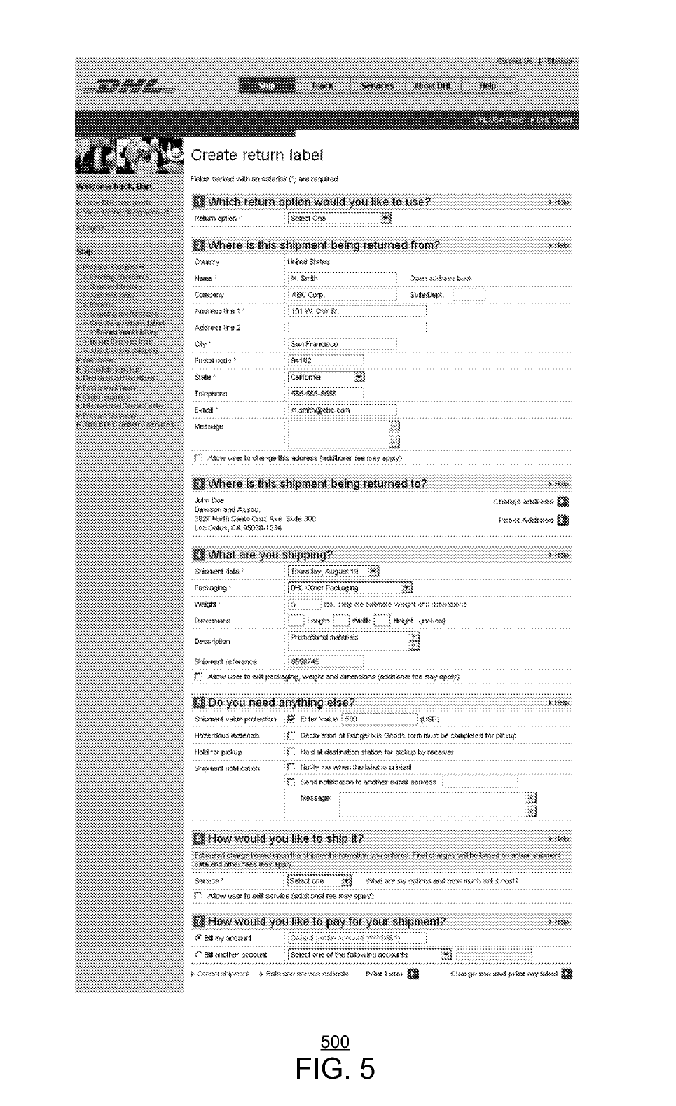

FIG. 5 is a diagram of a webpage for entering delivery options for implementation in the return label in accordance with an exemplary embodiment of the present invention. The webpage is generally referred to by the reference number 500. A description of the various areas and fields of the webpage 500 is set forth below.

Users that select this option obtain their outbound label and their return label as an image. This label image is handled in the same fashion as PR labels that produce two labels.

Users that are billing their outbound shipment to a credit card are warned that their return label will be billed to their sender account.

Users have the option to select a link Next to the Print a Return Label link called ‘Help me with this link’. This content explains the other Return Label options.

### A “Create Return Label” Link can be Added to the Left Navigation

### Users

WebShip users with an account and CorpShip users which have been enabled to the use of Return Labels.

### Inputs

User navigates to WebShip/CorporateShip.

### Outputs

“Create return label” link on left navigation.

### The User Shall be Able to Create a Return Label.

### Users

WebShip users with an allowance for the use of Return Labels.

### Inputs

User navigates to the Create return label page.

### Outputs

A printed waybill or an e-mail.

### Business Rules

An exemplary embodiment of the present invention may include a return option drop down with the following options:
Select One (default—must be changed)
Print label
E-mail label
Premium e-mail label

A return label may in one exemplary embodiment of the invention may only be created for a domestic destination.

The user may select the “Notify me when the label is printed” option in order to receive an e-mail notification that the label has been created.

The user will be able to retrieve a rate estimate through the “What are my options and how much will it cost?” link and the “Rate and service estimate” link.

If Print label is selected the link at the bottom will read “Print my label” which will bring the user to a waybill preview page where they can print it and go on to the confirmation page.

If the e-mail label option is selected the bottom link will read “E-mail return label” which will send the e-mail and the user will be sent to a confirmation page.
The e-mail address field in the “Where is the shipment being returned from?” table will be required.
A message field will be added to the “Where is the shipment being returned from?” table.
The bottom link will read “E-mail return label” which will send an e-mail and direct the user to the confirmation page.

If the premium e-mail label option is selected:
The e-mail address field in the “Where is the shipment being returned from?” table will be required.
A message field will be added to the “Where is the shipment being returned from?” table.
An “Allow user to change this address” option will appear on the “Where is this shipment being returned from?”
An “Allow user change packaging, weight and dimensions” option on the “What are you shipping table.”
The link at the bottom will read “E-mail return label” which will send the e-mail and direct the user to a confirmation page.

The return label creator may only pay for the label with their DHL account number or a third party account number.

All return waybills will have a receipt.

Users shall have the option to select ‘Create another return label’ on the confirmation page which will take the user back to a blank create a return label page. Alternatively, users shall have the option to utilize the create another return module on the confirmation page to start a process of creating a return label.

When an e-mail receiver clicks on the link in the e-mail they could be directed to the “Waybill Preview” page.

### Users

All users who receive a return label e-mail.

### Inputs

User clicks link in e-mail.

### Outputs

Waybill preview page.

### Business Rules

If the user clicks on the retrieve waybill link in the e-mail they will be directed to the waybill preview page.

If the user clicks on the pickup link in the e-mail they will be directed to the schedule a pickup page with information from the return shipment pre-populated.

If the user clicks on the drop-off link in the e-mail they will be directed to the find drop off locations page with information from the return shipment pre-populated.

An e-mail with a link to the edit return label page could be sent to the “return from e-mail address” when a premium e-mail transaction is processed.

### Users

All users with or without an account.

### Inputs

All required information on the Create return label page with the premium e-mail option selected.

### Outputs

E-mail with a link to the edit return label page.

### Business Rules

If an unauthenticated user clicks on the edit and print waybill link in a “premium e-mail label” method e-mail then they will be directed to the edit return label splash page.

If an authenticated user clicks on the edit and print waybill link in a “premium e-mail label” method e-mail then they will be directed to the edit return label page after logging in.

If an authenticated or unauthenticated user clicks on the print waybill link in an “e-mail label” method e-mail they will be given the option to print the label with an installed printer.

If an unauthenticated user clicks on the pickup link in an electronic return label method e-mail they will be directed to the schedule a pickup page without the details from the return shipment pre-populated.

If an authenticated user clicks on the pickup link in an electronic return label method e-mail they will be directed to the schedule a pickup page with the details from the return shipment pre-populated.

If an unauthenticated user clicks on the drop-off link in an electronic return label method e-mail they will be directed to the find drop off locations page without the details from the return shipment pre-populated.

If an authenticated user clicks on the drop-off link in an electronic return label method e-mail they will be directed to the find drop off locations page with the details from the return shipment pre-populated.

The “Edit return label” page could display and allow the user to edit the detailed information related to their return label.

### Users

WebShip users with and without an account.

### Inputs

User clicks link in e-mail.

### Outputs

Edit return label page.

### Formats (Authenticated User)

Also see appendix D for more detailed field information related to the following business rules.

### Formats (Un-Authenticated User)

Also see appendix D for more detailed field information related to the following business rules.

### Business Rules

The user may edit their address information if the return label creator has enabled that option.

The user must select the ship date (System date+9 days minus Sundays).

The user may edit the package, service, weight and dimensions if the return label creator has enabled that option.

The return to address will be non-editable.

If the return label creator entered a value for description and/or shipment reference they will be displayed as non-editable.

If the return label creator did not enter a value for description and/or shipment reference they will be displayed as editable.

The hold at destination station and shipment value protection will not be viewable. Once the user has finished editing the return shipment and clicks on print may label a preview of the label will appear.

### Return Label Options Could be Added to the Shipping Preferences Page.

### Users

WebShip users with an account that has been enabled to the use of Return Labels.

### Inputs

User goes to the Shipping Preferences page.

### Outputs

New section on page with Return Label processing options.

### Formats

### Business Rules

A new section will be added to the Shipment Preferences page called Return label options with the following options:
Return option
Service type
Shipment weight
Shipment Value Protection
Description

The preferences the user sets here will be pre-populated on the Create return label screen. Return Label options could be added to the CA Setup options page.

### Users

Authenticated Corporateship administrators.

### Inputs

CA goes to Setup Options page.

### Outputs

New section on page with new Return Label processing options.

### Formats

### Business Rules

A new section will be added to an options page—especially for an administrator—called “Select return label options and settings for your users” with the following options:
Allow users to create print return labels.
Allow users to create e-mail return labels.
Allow users to create premium e-mail return labels.

All three return label options will be defaulted unchecked. If none of the options are checked:
The Return label options on the CorporateShip users preferences page will not appear.
The Create return label link on the left navigation will not appear.
The Create return label based on this shipment link on the prepare shipment confirmation page will not appear.

If one or more of the options is checked:
The Return Label option will be added to the CorporateShip user's shipping preferences page.
The Create return label link on the left navigation will be added.
The Create return label based on this shipment link on the prepare shipment confirmation page will be added.

If “Allow users to create print return labels”, “Allow users to create e-mail return labels” or “Allow users to create premium e-mail return labels” check boxes are not selected then that un-selected option will not appear in the user's return option drop down box menu.

The return label creator should in one preferred embodiment not be billed for the shipment until the label is scanned.

### Users

N/A

### Inputs

The return label is scanned for shipment.

### Outputs

The user is billed for the shipment.

### Formats

N/A

### Business Rules

The return label creator will not be billed for the shipment until the return label has been scanned.

A user could be able to create a printed or e-mail return label for mail list shipments.

### Users

WebShip users with an account.

### Inputs

User selects a mail list then selects the “Create return labels” button on the mail list page or uses the “Create return label” link on the confirmation page of a mail list shipment.

### Outputs

Mail list Create return label page.

### Formats

### Business Rules

The user will have the ability to create return labels for a mail list.

Users will only be able to create mail list return labels using the print label or e-mail label return option and not the premium e-mail label return option. The return option drop down shall contain the following options:
Select One (default—must be changed)
Printed labels
E-mailed labels

### Business Rules

If an e-mail or premium e-mail return label is voided then an e-mail will be sent to the return from party to notify them it has been voided.

If a user clicks the link n the e-mail to get to the return label after the label has been voided, they will be given an error page that reads, “We're sorry, this label has been voided.”

When the user navigates to the Return Solutions page there will be a Return label section with an introduction and a learn more link.

The learn more link will lead to an article page containing more information about the Return Labels tool and a link that will bring the user to the Create a return label page.

It is also possible to integrate mail list return labels.

It is possible to print the return lables with various printers, for example by using thermal printing.

It is furthermore possible to display information trough pending shipments and shipment history. A preferred embodiment of the invention includes a process in which potential shipments and activated shipments are displayed.

In order to facilitate a change of attributes by users—especially before printing a label—it is advantageous to implement a securing process. For example this can be archived by an excess to a limited area. It is especially advantageous to integrate this solution in a web based solution, and to integrate additional security features as for example cookies and/or a login.

It is furthermore possible to treat the status of a return label and to notify a user, especially a user voiding a printed label to notify the intended receiver of the shipment.

An exemplary embodiment of the present invention includes different ways for payment processes, for example by credit card.

It is possible, to include different payment options, e.g. by credit card. An exemplary embodiment of the present invention includes a confirmation page which can optionally be combined with a further link for creating another return label.

The “create another return label” link allows a user to go back to the return label page without using the module on the confirmation page.

According to a preferred embodiment of the invention, the pick up and drop off location pages are displayed in separate windows at a graphical user interface (GUI).

It is furthermore advantageous to include a dynamic in the representations on the graphical user interface, e.g. based on whether or not the user is allowed to create return labels.

It is furthermore advantageous to add return labels to a pending shipments page. According to an exemplary embodiment of the present invention, the user will not be billed unless the shipment is scanned.

This implementation includes the idea, that a scanning or another handling of the shipment initiates the billing process.

It is furthermore advantageous to implement a shipment history.

A communication module comprised by the computer system may comprise tools that allow the system to communicate with multiple devices using multiple message formats, e.g. voice mail, text message, etc., that are streamed through multiple communication means. For example, the system may automatically generate a voice message that is communicated to a courier by telephone, in which case the system utilizes the tools of the communication module to communicate with the courier.

The computer system may further comprise means for automatically sending an e-mail draft message or an instant draft message to a user, for example the original shipper creates and/or the original receiver of an item.

In another preferred embodiment the computer system comprises means for retrieving shipping information and/or for validating shipping.

Exemplary embodiments of the present invention are described herein in terms of methods and computer systems implementing those methods. It will be apparent, however, to one with ordinary skill in the art that exemplary embodiments of the present invention may be implemented as computer software, e.g. computer program code, capable of being stored in a computer memory and executed by a microprocessor.

Each component or module of the computer system may be implemented as part of a larger infrastructure, e.g. within an application server, or as one or more plug-in programs, applets, dynamically loaded libraries, or any other configuration that allows programs to run on one or more computers in order to provide shipping information management. The programs may be embedded within, or interfaced with third party applications. Although described in modular terms for purposes of illustration, exemplary embodiments of the present invention need not be limited to modular implementations. The functionality described herein may be implemented in software and/or hardware as a single process or as a combination of multiple processes and/or applications.

Additional components of the computer system may reside in a server that customers are able to access remotely using, for example, web browser software such as Internet Explorer or Netscape Navigator. Embodiments of such computer systems may also include a client application that executes on the customer's computer. The client application may execute as a separate process, or as a helper application that extends a web browser's capabilities and enables the latter to communicate with the computer system. The client application may collect certain data related to shipping transactions from the customer's computer, and detect such transactions when the customer fills in a shipping bill form.

The customer may register with the computer system to provide information such as the customer's address, customer billing information, e.g. credit card information, and customer shipping preferences. Subsequent to registration, the customer may access the system using authentication methods, e.g. user identification and password parameters.

One or more exemplary embodiments of the invention may work with and/or in support of third party shipping and mailing software tools. For example, the client application may be automatically activated when the customer prints a shipping bill form. As part of the shipping bill form printing process, the customer provides transaction-specific information about the shipment, such as the selected class of shipping, the destination address, the weight and/or size of the package(s), etc. Further transaction-specific information, e.g. value, corrected address, etc. may be derived by the back-end of the computer system based on the customer's information.

While exemplary embodiments are described herein, the various aspects of the present invention may be used with various types of computer systems, generally including all system designs which link together disparate processing units such as computers, servers, peripherals, storage devices, and devices for data communications. Examples of such computer systems may include a local area network (LAN), a wide area network (WAN), a metropolitan area network (MAN), and a global area network (GAN).

Exemplary embodiments of the present invention relate to an Internet/XML solution, although the scope of the present invention is not limited thereto. A wide variety of exemplary embodiments, arrangements and configurations of terminals, switches and links in all types of data networks may be utilized.

A computer system according to an exemplary embodiment of the present invention may include a plurality of component modules. These software component modules may be either commercially available off-the-shelf software, customized software or independently developed software. For example, freight rate databases are commercially available. If they are robust and capable of integration with other software components to accomplish the workflows described below, then they can be utilized in the computer system.

The computer system may be centralized in one or relatively few locations or may be distributed throughout a relatively large number of locations. As will be made clear below, each physical shipment represents a plurality of different related work process flows, such as a shipment offer, a shipment acceptance, a customs clearance, in the system. Furthermore, the duty to be paid for a shipment may be calculated in various phases of the plurality of different related work process flows.

Other features of an exemplary embodiment of the present invention may be apparent to those skilled in the art from the detailed description of the example embodiments and claims when read in connection with the accompanying drawings. While the foregoing and following written and illustrated disclosure focuses on disclosing exemplary embodiments of the present invention, it should be understood that the same is by way of illustration and example only, is not to be taken by way of limitation and may be modified in learned practice of an exemplary embodiment of the present invention. While the foregoing has described what are considered to be exemplary embodiments of the invention, it is understood that various modifications may be made therein and that the invention may be implemented in various forms.

Reference herein to “one embodiment” or “an embodiment” means that a particular feature, structure, or characteristic described in connection with the embodiment can be included in at least one implementation of the invention. The appearances of the phrase “in one embodiment” in various places in the specification are not necessarily all referring to the same embodiment, nor are separate or alternative embodiments necessarily mutually exclusive of other embodiments.

While exemplary embodiments of the present invention may be susceptible to various modifications and alternative forms, specific embodiments have been shown by way of example in the drawings and will be described in detail herein. However, it should be understood that exemplary embodiments of the present invention are not intended to be limited to the particular forms disclosed. Rather, exemplary embodiments of the present invention relate to all modifications, equivalents and alternatives falling within the spirit and scope of the invention as defined by the following appended claims.

One or more exemplary embodiments of the present invention are described herein. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Certain aspects commensurate in scope with the disclosed embodiments are set forth below. It should be understood that these aspects are presented merely to provide the reader with a brief summary of certain exemplary embodiments of the invention might take and that these aspects are not intended to limit the scope of the invention. Indeed, exemplary embodiments of invention may encompass a variety of aspects that may not be set forth herein.

What is claimed is:

1. A method for creating a label, comprising:
creating allowance information to allow an original receiver to enter shipment information;
allowing the original receiver to activate an option to create a return label;
and
enabling the original receiver of the item to print the return label.

2. The method according to claim 1, comprising attaching the return label to a received item.

3. The method according to claim 2, comprising returning the received item to an original shipper according to the shipment information.

4. The method according to claim 1, comprising enabling the original receiver to modify the shipment information.

5. The method according to claim 1, comprising transmitting a link to the return label to the original receiver.

6. The method according to claim 1, comprising displaying a preview of a waybill that includes the shipping information.

7. The method according to claim 1, comprising printing the return label.

8. The method according to claim 1, comprising displaying a confirmation page when the return label has been printed.

9. The method according to claim 1, comprising emailing the allowance information to the original receiver.

10. A tangible, machine-readable medium, comprising:
machine-readable code that creates allowance information to allow an original receiver to enter shipment information;
machine-readable code that allows the original receiver to activate an option to create a return label; and
machine-readable code that enables the original receiver of the item to print the return label.

11. The tangible, machine-readable medium according to claim 10, comprising machine-readable code that enables the original receiver to modify the shipment information.

12. The tangible, machine-readable medium according to claim 10, comprising machine-readable code that transmits a link to the return label to the original receiver.

13. The tangible, machine-readable medium according to claim 10, comprising machine-readable code that displays a preview of a waybill that includes the shipping information.

14. The tangible, machine-readable medium according to claim 10, comprising machine-readable code that prints the return label.

15. The tangible, machine-readable medium according to claim 10, comprising machine-readable code that displays a confirmation page when the return label has been printed.

16. A logistics system that is adapted to carry out the transport or handling of at least one item, where in the item is transported from an original shipper to an original receiver, the logistics system comprising:
a computer that produces a user interface that allows an original shipper to create allowance information which allows an original receiver to enter shipment information and to activate an option for a creation of a return label, the user interface being adapted to allow an original receiver to print and/or modify the return label.

17. The logistics system according to claim 16, wherein the logistics system is adapted to allow the original receiver to return the received item to an original shipper according to the shipment information.

18. The logistics system according to claim 16, wherein the logistics system is adapted to enable the original receiver to modify the shipment information.

19. The logistics system according to claim 16, wherein the logistics system is adapted to transmit a link to the return label to the original receiver.

20. The logistics system according to claim 16, wherein the computer is adapted to display a preview of a waybill that includes the shipping information.
